(19) United States
(12) Patent Application Publication
(10) Pub. No.: US 2002/0042848 A1
(43) Pub. Date: Apr. 11, 2002

(54) Method of providing services in a network management system having an open system architecture and also a service object, a request object and a request manager therefor

(75) Inventor: Martin Takats, Berlin (DE)

Correspondence Address: SUGHRUE, MION, ZINN, MACPEAK & SEAS, PLLC, 2100 Pennsylvania Avenue, N.W., Washington, DC, 20037-3213, US

(73) Assignee: ALCATEL

(21) Appl. No.: 09/968,916

(22) Filed: Oct. 3, 2001

(30) Foreign Application Priority Data
Oct. 5, 2000 (EP) 100 49 619.9

(51) Int. Cl. G06F 15/173; G06F 9/00; G06F 9/46

(52) U.S. Cl. 709/316; 709/318

(57) ABSTRACT

The present invention relates to a method of providing services, in particular in a network management system having an open system architecture, and also to a service object, a request object and a request manager therefor. In the method, at least a first and a second object name are assigned to the service object. The request object transmits to the service object a request message in which the first or the second object name is specified as address information for the service object. The service object provides at least a first or a second service depending on the first or second object name used in the respective request message.

### BACKGROUND OF THE INVENTION

The present invention relates to a method of providing services, in particular in a network management system having an open system architecture, and also to a service object, a request object and a request manager therefor.

The invention is based on a priority application DE 100 49 619.9 which is hereby incorporated by reference.

In known systems with an open system architecture, for example a network management system with which a computer network, for example a telecommunications network, is managed and controlled, services are provided by so-called service objects for the request objects requesting the respective services.

In a first example, the request object is formed by an interrogation process performed on a client computer, which process transmits database interrogation messages to a database process that is performed by a server computer and serves as service object for interrogating a database stored therein. The interrogation process must in each case specify for the database in the database interrogation messages precisely and comprehensively the interrogation criteria according to which the database interrogation is to take place. To form complex database interrogation messages, a lot of “intelligence” has to be present in the request object so that the latter can be created only with high effort and, for example, requires a complex programming. In addition, the database interrogation messages are built up in a complicated manner and require transmission capacity for communicating the interrogation criteria.

Such a request object is, for example, a management object that manages so-called managed objects that represent, for example, a switching centre, a router or a network service. The management object is, for example, a computer of a network management centre or a network management process performed by such a computer. The management object requires items of information about the respective status of the managed object. For this purpose, the latter transmits so-called event reports relating, for example, to a defect in the managed object, transgression of a limit value or the change in the configuration state of the managed object. The management object displays the event messages, for example on a user interface, and transmits control commands to the computer network and/or the managed object, for example, in order to eliminate the defect state.

Typically, the event reports are not sent directly by the managed objects to the management object assigned to them, but via so-called event forwarding discriminators (EFDs) that filter the event reports on the basis of filtering criteria described as “discriminator construct” and report to the management object only the event reports relevant to it. In this process, an EFD forms a service object (also referred to as “service agent”) that performs a service, namely the filtering of the event reports for the management object. A definition of an EFD can be found, for example, in the ITU Recommendation X.734 (ITU=International Telecommunication Union).

Described as event reports are reports that are sent spontaneously when an event occurs, whereas event state messages relate to events that may already have taken place some time ago. A generic term “items of event information” denotes event reports and event state messages. Event states and event reports relate not only to standard object attributes, for example “on duty” or “off duty”, but also, for example, so-called environmental alarms with which, for example, a fire alarm is reported.

In each case an EFD is assigned to one or more managed objects and, on the basis of predetermined filtering criteria, filters out those event reports that are irrelevant to the management object. An EFD employing individual filtering criteria as service objects is consequently necessary in each case for a single object or for a group of managed objects. The respective service objects have to be configured individually in each case and, possibly, even designed individually, for example by suitable programming. In addition, the respective network management system has to operate numerous service objects, which results in an appreciable system loading.

### SUMMARY OF THE INVENTION

It is therefore the object of the present invention to optimize the provision of services by service objects in a system having an open system architecture, in particular in a network management system.

This object is achieved by a method of providing services, in particular in a network management system having an open system architecture, the method comprising:

assigning at least a first and a second object name to a service object;

a request object forwards to the service object a request message in which the first or the second object name is specified as address information for the service object; and

depending on the first or second object name used in the respective request message, the service object provides at least a first or a second service.

This object is achieved by a service object for providing services, in particular in a network management system having an open system architecture,

to which at least a first object name and a second object name are assigned,

that has receiving means for receiving a request message in which the first or the second object name is specified as address information for the service object, and

that has service providing means for providing at least a first or a second service depending on the first or second object name used in the respective request message.

This object is achieved by a request object for utilizing services, in particular in a network management system having an open system architecture, comprising transmission means for transmitting at least one request message for a first and/or a second service to be provided by a service object, wherein the transmitting means are designed in such a way that the request object can specify, in the at least one request message, a first or a second object name assigned to the respective service object as address information for the service object depending on the respective first or second service to be provided by the service object.

This object is achieved by a request manager for providing services, in particular in a network management system having an open system architecture,

comprising receiving means for receiving a request message transmitted to a service object by a request object in which at least a first or a second service is requested by the service object depending on a first and/or second object name assigned to the service object and used in the respective request message as address information,

comprising transmitting means for transmitting the request message or a request derived therefrom via a first or a second, in particular logic transmission channel, respectively, to the service object that is assigned to the first or second object name so that the service object can provide the first or the second service, respectively, depending on the first or second transmission channel used for the respective request message.

In this connection, the invention is based on the idea that a service object or a service agent is addressed, so to speak, under different logic object names or agent names by a request object and in each case provides services assigned to the logic object name. The service object and the request object are preferably in each case a process or a group of processes that are performed by one or more computers, or they are a service computer or a request computer. In this connection, a service object may be assigned to one or more request objects. Thus, for example, it may be assigned under a first object name to a first request object and under a second object name preferably to a second request object or likewise to the first request object. Depending on which logic object name was used in the respective request, the service object provides a predetermined service. A single physical service object simulates, in this connection, a plurality of logic service objects and consequently reduces the system load in a network management system. Furthermore, the maintenance expenditure is reduced since it is not necessary to service a plurality of individual physical service objects, but only a single service object simulating a plurality of logic service objects or service agents.

In the example mentioned at the outset, the request object, that is to say the interrogation process performed by a client computer, transmits to the database process performed by the server computer and forming a service object database interrogation messages which specify, for example, a first or second object name assigned to the interrogation process, depending on the first or second interrogation criteria to be used for the database interrogation by the service object. The interrogation messages do not contain the interrogation criteria per se so that the interrogation messages are easy to form and require less transmission capacity. Depending on the respective first or second object name, the database process performs the database interrogation according to first or second interrogation criteria.

Expediently, the service object provides the various services in each case as a function of configuration data that are assigned to the object name respectively used. Consequently, the provision of services by the service object can be individually configured, a change in the configuration to adapt to instantaneous requirements being readily possible.

Advantageously, a first and a second object name could also be assigned to a first and/or a second request object. The first request object and/or the second request object then forward to the service object request messages in which the first or the second object name is specified as source information. Depending on the first or second object name used in each case in the request messages, the service object provides at least a first or a second service, respectively.

In a preferred variant of the invention, there is a request manager, so to speak, upstream of a service object. A request message transmitted by a request object is not transmitted directly to the service object, but first to the request manager. On the basis of the object name used in the request message, the latter determines the service object to which the request message or a request derived therefrom is to be forwarded. Depending on the respective object name, the request manager forwards the request message over a transmission channel assigned to the respective service object to the latter so that the relevant service object can determine from the transmission channel used in each case which service it has to provide.

It is, however, basically also possible that the request manager transmits the request messages that contain various object names as address information to the service object over a common transmission channel and adds to the respective request message an identifier indicating which service is to be provided. For example, configuration data used to provide the service and/or a reference to certain configuration data to be read in by the service object could be specified in the request message transmitted to the service object by the request manager.

In a particularly preferred variant of the invention, the request object is formed by a management object and the service object by a discriminator object. The discriminator object transmits to the management object event reports and/or at least one event state of at least one object managed by the management object, preferably, however, of a plurality of managed objects that represent, for example, a switching centre, a router or a network service. The event reports are, for example, alarm reports or change messages relating to new configuration data loaded by the respective managed object. In this connection, the discriminator object may, for example, perform the functions of an event forwarding discriminator (EFD), mentioned at the outset, in accordance with the definition of the ITU Recommendation X.734 (ITU=International Telecommunication Union). The management object is, for example, a computer of a network management centre or a network management process performed by such a computer. The management object addresses the discriminator object by various object names, for example by a first and a second object name. If the discriminator object receives a request message containing the first object name, it transmits, for example, the event reports of a first managed object and, in the case of a request message containing the second object name, it transmits the event reports of a second managed object.

In a development of the above preferred variant, the discriminator object supplies, depending on the object name used in the respective request message, various filtering criteria to determine the events relevant to the management object in the event reports and/or in the at least one event state. The filtering criteria may, for example, be stored as configuration data or, if the request manager mentioned is provided, it may also, for example, be specified by the latter in the respective request message.

In a further development of the above preferred variant, the discriminator object transmits, depending on the object name used in the respective request message, a request message to one or more managed objects to request its respective event state. On the basis of the respective object name, the discriminator object determines the managed object to which such a request message is to be sent. The latter then report their respective event state to the discriminator object which preferably uses, depending on the object name used by the management object, various filtering criteria for determining the events relevant to the management objects in the event reports and/or in the at least one event state.

It goes without saying that any combination is possible of the measures specified in the subclaims and in the description.

### BRIEF DESCRIPTION OF THE DRAWINGS

The invention and its advantages are presented below with reference to an exemplary embodiment with the aid of the drawing.

FIG. 1 shows a diagrammatic arrangement for performing the method according to the invention comprising management objects MO1, MO2, discriminator objects, DO1, DO2, managed objects VO1, VO2 and VO3 and a request manager RM.

FIG. 2 shows the managed object VO1 diagrammatically and by way of example for the managed objects VO1, VO2, VO3.

FIG. 3 shows the discriminator object DO1 diagrammatically and by way of example for the discriminator objects DO1 and DO2.

FIG. 4 shows the management object MO1 diagrammatically and by way of example for the management objects MO1, MO2.

FIG. 5 shows request messages AN1 and AN2.

FIG. 6 shows request messages AN3 and AN4.

### DETAILED DESCRIPTION

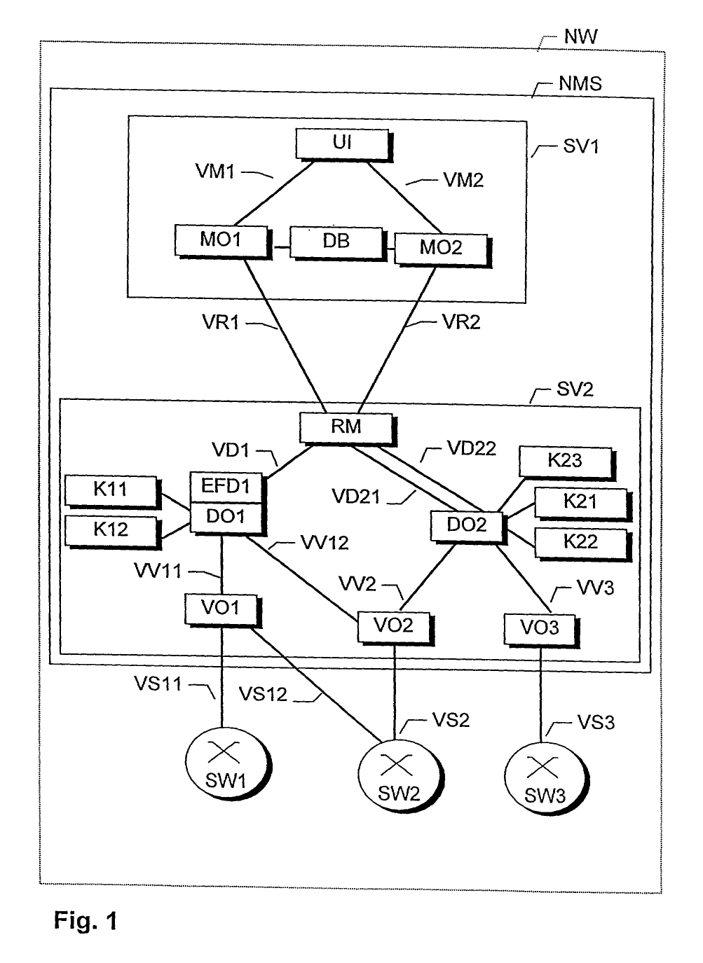

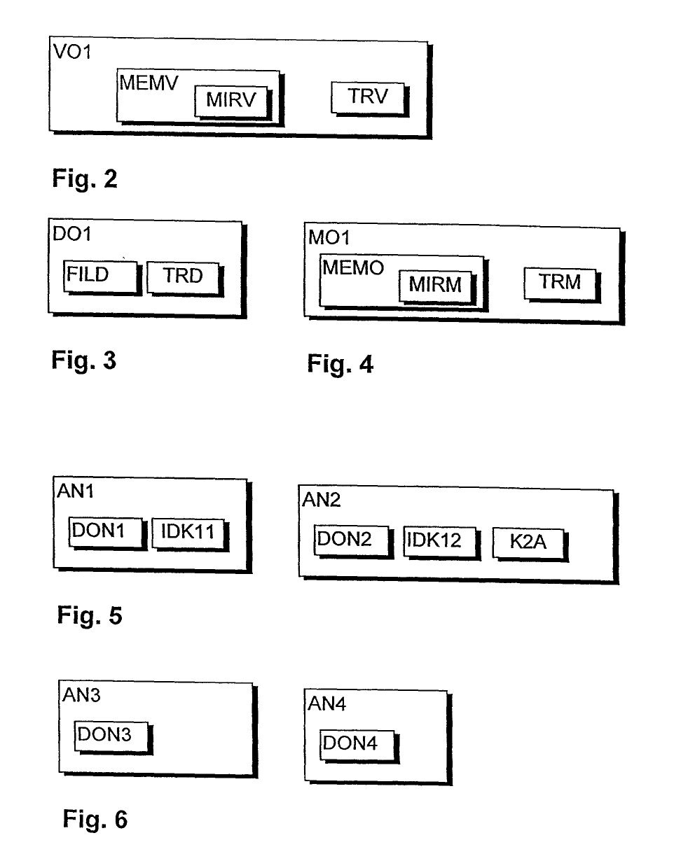

FIG. 1 shows a telecommunications network NW comprising servers SV2 and SV1 of a network management system NMS having an open system architecture and also network devices SW1, SW2 and SW3, which are, for example, switching centres, routers or service computers for providing intelligent network (IN) services. The network devices SW1, SW2 and SW3 are each managed, maintained and operated by the network management system NMS. The telecommunications network NW also comprises further devices that are not shown, for example, further network devices or terminals operated by the network devices SW1, SW2 and SW3. The network devices SW1, SW2 and SW3 are represented by so-called managed objects VO1, VO2 and VO3, respectively. The managed objects VOl, VO2, VO3 are in the present case processes or groups of processes whose program code is executed by the server SV2 and that pre-process the items of event information transmitted by the network devices SW1, SW2 and SW3 to the network management system NMS. Furthermore, the network devices SW1, SW2 and SW3 can be controlled via the managed objects VO1, VO2, VO3. The managed objects VO1, VO2, VO3 are, for example, so-called proxy agents that simulate, so to speak, the network devices SW1, SW2 and SW3 for the network management system NMS at least in regard to predetermined characteristics. A proxy agent converts the instructions transmitted by the network management system NMS in such a way that they are understood by the managed network devices SW1, SW2 and SW3. The managed objects VOl, VO2, VO3 may also represent only certain characteristics of the network devices SW1, SW2 and SW3, for example their alarms.

However, it is also possible that separate managed objects are provided in each case for controlling the network devices SW1, SW2 and SW3 and for processing their items of event information. Further objects similar to the managed objects VO1, VO2, VO3 could be provided in order to represent a network service or another resource in the telecommunications network NW. Furthermore, a plurality of managed objects could be assigned to a resource and represent the latter in various ways. For example, the managed object VO1 could represent the alarms of the network device SW1 and the managed object VO2 its measurements or its currently loaded configuration data. The managed objects VO1, VO2, VO3 could also be formed directly by the network devices SW1, SW2 and SW3, respectively, or be processes performed by the latter.

Provided to manage, operate and maintain the managed objects VO1, VO2, VO3 are management objects MO1, MO2 that are designed as processes or groups of processes performed by the server SV1. It is also possible that the server SV1 forms a management object itself or that each of the management objects MO1, MO2 is a process performed by a separate computer of the network management system. Provided, furthermore, in the server SV1 is a user interface UI via which events reported by the network devices SW1, SW2 and SW3, for example the violation of a limit value or activation of freshly loaded configuration data, are outputted on a display device, for example a monitor, and, optionally, also audibly. Via the user interface Ul, a user may also transmit commands for controlling the network devices SW1, SW2 and SW3 to the latter, for example activate or deactivate a connection.

The servers SV1 and SV2, not shown in greater detail, are computers or computer networks that are operated by a UNIX operating system or a Windows NT operating system. The servers SV1 and SV2 have transmitting and receiving means, for example LAN or WAN interface cards, modems or the like, with which data can be transmitted or received. Furthermore, memory means, for example hard disks and RAM chips, and also control means, for example a processor in each case or a cluster of processors, are provided. Such a control means performs instructions of an operating system that is stored in the memory means. Furthermore stored in the memory means are program code sequences of program modules that are carried out by the control means and control the functions of the servers SV1 and SV2. Such program modules in the server are the management objects MO1 and MO2 and the user interface UI, and also the managed objects VO1 to VO3 in the server SV2. The transmitting and receiving means, control means and memory means of the servers SV1 and SV2 and their respective internal interconnections are not shown in FIG. 1.

The network devices SW1 and SW2 transmit items of event information to the managed objects VO1 and VO2 via connections VS11 and VS12, respectively. The network devices SW2 and SW3 transmit items of event information to the managed objects VO2 and VO3 via connections VS2 and VS3, respectively. At the same time, the network devices SW1, SW2 and SW3 report, for example, limit value violations, their current system load or traffic loads of connections in the telecommunications system NW. The items of event information are forwarded, for example, as structured data, for example, with the aid of the basic encoding rules BER in accordance with the definitions of the International Telecommunication Union. The items of event information between the network devices SW1, SW2 and SW3 and the managed objects VO1, VO2, VO3 may, however, also be so-called object request broker objects (ORB), for example, in accordance with the CORBA specification (CORBA=common object request broker architecture) of the OMG (object management group) or the DCOM specification of Microsoft. The connections VS11, VS12, VS2, VS3 are shown only diagrammatically and are preferably routed via a separate management network, for example via a WAN (wide area network).

Items of event information transmitted by the network devices SW1, SW2 and SW3 are received by the managed objects VO1, VO2, VO3 via transmitting and receiving means TRV and stored in a memory means MEMV. The transmitting and receiving means TRV and the memory means MEMV are in the present case performed as corresponding program functions of the managed objects VO1, VO2, VO3. Consequently, an image or a mirror MIRV of the events that have occurred in the network devices SW1, SW2 and SW3 are stored in each case in the managed objects VO1, VO2, VO3.

The managed objects VO1, VO2, VO3 report the respective items of event information as event information objects via connections W11, W12 and W2, W3 to discriminator objects DO1 and DO2, respectively, that are designed in the present case likewise as processes or agents performed by the server SV2. The discriminator objects DO1, DO2 receive the items of event information via transmitting and receiving means TRD and filter the items of event information on the basis of filtering citeria K11, K12, K21, K22 with the aid of filtering means FILD. The transmitting and receiving means TRD and also the filtering means FILD are designed in the present case as corresponding program functions of the discriminator objects DO1, DO2, DO3 and form service providing means for providing services for the management objects MO1, MO2.

For example, the discriminator object DO1 filters the items of event information intended for the management object MO1 and originating from the managed object VO1 on the basis of filtering criteria K 11 and the items of event information intended for the management object MO2 and originating from the managed object VO2 on the basis of the filtering criteria K12. The filtering criteria K11, K12 and K21, K22 are attributes of the discriminator objects DO1 and DO2, respectively, and are described, for example, as discriminator constructs. The filtering criteria K11, K12 and K21, K22 specify the conditions which the items of event information transmitted by the managed objects VO1, VO2, VO3 must fulfil if they are to be transmitted to the management objects MO1, MO2. The filtering criteria K11, K12, K21, K22 may be designed, for example, as test tables to be applied by the filtering means FILD or as test functions to be invoked by the filtering means FILD. In any case, the respective items of event information relating to events that are irrelevant for the management objects MO1, MO2 are filtered out by the filtering means FILD, in which process, for example, a noncritical limit value violation or a cyclically reported measured value is separated out, whereas a critical malfunction or any other alarm is passed on.

The discriminator objects DO1 and DO2 transmit items of event information not filtered out via connections VD1 or VD21, VD22, respectively, to a request manager RM, which conveys the items of event information via connections VR1 and VR2 to the management objects MO1 and MO2, respectively. The discriminator object DO1 only enters a logic address of the management objects MO1, MO2 into the items of event information it transmits, whereas a forwarding object EFD1, for example an event forwarding discriminator EFD in accordance with ITU recommendation X.734 (ITU=International Telecommunication Union), upstream of the discriminator object DO1 in the direction of the request manager RM enters a physical address assigned to the respective logic address in the respective items of event information. The discriminator object DO2, on the other hand, already enters the necessary physical addresses without the cooperation of a forwarding object.

For the discriminator object DO1, provision may, for example, be made that it passes on to the forwarding object EFD1 all the items of event information, that is to say not only those intended for forwarding but also those intended for filtering out, but adds to the latter attributes “forward” or “do not forward” determined on the basis of the filtering criteria K11 and K12.

It is also possible that a discriminator object duplicates some of the items of event information transmitted by managed objects and forwards them repeatedly to management objects assigned to it. For example, the discriminator object DO1 transmits items of event information reported by the managed objects VO1, VO2 to each of the two management objects MO1, MO2. The discriminator object DO1 receives the items of event information, for example, as input objects and determines, on the basis of the filtering criteria K11 and K12, which of the input objects are to be sent to the management object MO1 and which to the MO2. If necessary, the discriminator object DO1 copies such an input object in order to transmit it both to the management object MO1 and to the management object MO2. In any case, the discriminator object DO1 adds the logic addresses of the management objects MO1, MO2 in each case as attributes to the input objects and then feeds them to the forwarding object EFD1.

The management objects MO1, MO2 receive the items of event information transmitted by the discriminator objects DO1 and DO2 via transmitting and receiving means TRM and store the items of event information, for example, in event mirrors MIRM that are provided in their memory means MEMO. In the exemplary embodiment, the management objects MO1, MO2 store the items of event information additionally in a database DB of the server SV1. Furthermore, the management objects MO1, MO2 forward the items of event information, for example, via internal connections VM1, VM2 provided in the server SV1 and preferably designed as interprocess connections to the user interface UI for outputting to the user. The transmitting and receiving means TRM, and also the memory means MEMO are designed in the present case as corresponding program functions of the management objects MO1, M02.

The connections VR1 and VR2 are routed, for example, via a LAN (local area network) connecting the servers SV1 and SV2. The connections W11, W12, W2, W3 and also VD1, VD21, VD22 are internal connections in the server SV2 that are routed via physical, but in particular, via logical transmission channels and are made, for example, via known interprocess communication mechanisms provided, for example, by the operating system of the server SV2.

For the purpose of data transmission over the connections VR1 and VR2, for example, the CMIP protocol (common management information protocol) of the OSI (open systems interconnection) or the TCP/IP-based simple network management protocol (=SNMP; TCP/IP=transmission control protocol/Internet protocol) are used, which are all suitable for transporting items of management information.

Insofar as the spontaneous transmission described of items of event information proceeds without fault through the network devices SW1, SW2 and SW3 to the management objects MO1, MO2, the event states of the network devices SW1, SW2 and SW3 are known in the server SV1. If, however, the connections VR1, VR2, for example, are lost for a short time owing to a line fault, items of event information spontaneously reported by the network devices SW1, SW2 and SW3 are possibly lost.

If the management objects MO1, M02, receive, for example, a report from a monitoring process, not shown, of the server SV1 that such a line fault is “outgoing”, that is to say no longer present, it transmits request messages to interrogate the event states of the managed objects VO1, VO2, VO3 to the discriminator objects DO1 and DO2 in order, for example, thereby to update its event mirror MIRM and the database DB.

In this case, the discriminator objects DO1 and DO2 form service objects and the management objects MO1, MO2 form request objects, under which circumstances the service objects provide services for the request objects. The management objects MO1, MO2 could also be described as managers, and the discriminator objects DO1 and DO2 as agents.

It is also possible for commands to be transmitted from the user interface UI to the management objects MO1, MO2 that initiate request messages addressed to the discriminator objects DO1 and DO2. Furthermore, the discriminator objects DO1 and DO2 and/or the managed objects VO1, VO2, VO3 could also report to the management objects MO1, MO2 that a divergence has occurred between the respective event mirrors MIRV and MIRM, respectively, whereupon the management objects MO1, MO2 then transmit appropriate request messages to the discriminator objects DO1 and DO2 to interrogate the event state.

Furthermore, a time-controlled control program provided in the server SV1 and/or in the server SV2 could transmit request messages. The time-controlled control program transmits the request messages at predetermined points in time, for example once an hour or on some weekdays, to the discriminator objects DO1 and DO2. The timecontrolled control program could be a so-called external scheduler designed as a separate process or, alternatively, an internal scheduler that is, for example, incorporated in the management object MO1 or in the discriminator object DO1 as a program function.

A first variant of the processing of such request messages will be described using the example of request messages AN1 and AN2 with which the management object MO1 requests the event states of the managed objects VO1 and VO2 from the discriminator object DO1. The request messages AN1 and AN2 are, for example, so-called “GET” messages, “EVENT-REPORT” messages or “ACTION” messages, which are defined within the framework of the Common Management Information Services (CMIS) or corresponding SNMP request messages. It is also possible that the request messages AN1 and AN2 are forwarded by objects in another form, for example, in the form of CORBA objects. To transmit the objects, the Internet InterObjectRequestBroker Protocol (IIOP) defined by the OMG already mentioned may be used and this can be transmitted within the framework of the TCP/IP (TCP/IP=transmission control protocol/Internet protocol). Furthermore, the request messages AN1 and AN2 could also be so-called remote procedure calls (RPCs) with which the management object MO1 invokes the objects VO1 and VO2, designed as processes or “procedures”, in the server SV2.

The management object MO1 transmits the request messages AN1 and AN2 via the connection VR1 to the request manager RM, which receives the request messages AN1 and AN2 using transmitting and receiving means, not shown in greater detail and designed, for example, as program functions and forwards them to the discriminator object DO1. In the request message AN1, “DON1” is specified as object name and consequently as addressed information for the discriminator object DO1 and in the request message AN2, “DON2” is specified as object name and address information. The object names DON1 and DON2 are assigned to the discriminator object DO1 and serves to address it logically. From the point of view of the management object MO1 there exist, under these circumstances, two service objects: a discriminator object designated by DON1 that interrogates the event state of the managed object VO1 as a service and a discriminator object designated by DON2 that interrogates the event state of the managed object VO2 as a service. The transmitting and receiving means TRM of the management object MO1 enter the object names DON1 and DON2 in the respective request message, depending on the service requested in each case.

On the basis of the object names DON1 and DON2, respectively, the request manager RM determines, for example, with the aid of an assignment table of object names-to-service object and/or a predetermined assignment algorithm that the request messages AN1 and AN2 are intended for the discriminator object DO1. In this connection it is also possible that the request manager RM inserts an additional identifier in the request messages AN1 and AN2 on the basis of which the discriminator object DO1 can determine the service to be provided in each case.

The discriminator object DO1 receives the request messages AN1 and AN2 using its transmitting and receiving means TRD. On the basis of the object names DON1 and DON2 serving as identifiers, the discriminator object DO1 recognizes which service it is to provide, namely that it should report the event states of the managed objects VO1 and VO2, respectively, to the management object MO1. An appropriate assignment of the object names DON1 and DON2 to a service to be provided in each case is advantageously stored in the configuration data of the discriminator object DO1.

For the purpose of processing the request messages AN1 and AN2, the discriminator object DO1 transmits an interrogation message in each case via the connections W11 and W12, respectively, in order to interrogate the event state of the managed objects VO1 and VO2, respectively. The latter report the event states, stored in their respective event mirrors MIRV, of the network devices SW1 and SW2, respectively, in individual event-state messages or in a contiguous event-state report to the discriminator object DO1. It is also possible that the managed objects VO1, VO2 additionally also forward interrogation messages to the network devices SW1, SW2 in order to interrogate their current event states in each case, for example, to interrogate faults.

The discriminator object DO1 receives the event state messages via its transmitting and receiving means TRD and, with the aid of the filtering means FILD, checks whether the event-state messages relate to events that are relevant to the management object MO1. The filtering means could use the filtering criteria K11 and K12 in the manner mentioned in order to filter the event-state messages originating from the managed objects VO1 and VO2, respectively. In that case, the object names DON1 and DON2 would be the identifiers for determining the filtering criteria K11 and K12 that are to be used and that are a component of the configuration data for the discriminator object DO1. In the present case, however, identifiers IDK11 and IDK12, respectively, that instruct the discriminator object DO1 to use the filtering criteria K11 or K12, respectively, for the event-state messages reported by the managed objects VO1 and VO2, respectively, are specifically specified in the request messages AN1 and AN2. In addition, still other filtering criteria K2A that are to be used to filter event states are specified in the request message AN2. For example, the filtering criteria K2A may determine that only alarm states but not measurements of the managed objects VO2 are to be reported to the management object MO1.

The request messages AN1 and AN2 may also contain further information, not explained in greater detail, for example the address of the management object MO1, which serves as destination address for feeding back the event states.

If an event-state message contains the state of an event that is not relevant for the management object MO1, it is filtered out, otherwise the event state is reported to the management object MO1 via the request manager RM. The respective message is reformatted, if necessary, into a message form that is intelligible for the management object MO1 by the discriminator object DO1.

In the present example, the managed objects VO1 and VO2 each report only the currently valid event states. In principle, the discriminator object DO1 could also check whether a reported event state is currently valid. If, for example, measurements are to be transmitted cyclically, it is possible to determine on the basis of time information added to a respective measurement whether a predetermined transmission cycle for the measurement has been kept to.

The management object MO1 receives the event-state messages or the event-state reports from the discriminator object DO1 via its transmitting and receiving means TRM and updates the respective events in its events mirror MIRM and in the database DB. In this connection, means may be provided in the management object MO1 for plausibility-checking the events, for example items of time information that are added to a reported event state could be compared with items of time information deposited in a stored event state. Furthermore, the plausibility-checking means could detect a deviation from a state of an event in the event mirror MIRM from an event state reported by the discriminator object DO1. If such a deviation occurs, on the one hand, a warning message is, for example, outputted at the user interface UI and, on the other hand, a safety interrogation is transmitted to the management object reporting the event state and/or the discriminator object in which they are instructed to check whether the reported deviation of the event state is correct.

A second variant of the processing of request messages transmitted by a request object to a service object will be below explained using the example of request messages AN3 and AN4 with which the management object MO2 requests the event states of the network devices SW2 and SW3, respectively, from the discriminator object DO2.

The management object MO2 transmits the request messages AN3 and AN4, in which the object names DON3 and DON4, respectively, are specified as logic addresses, to the request manager RM. From the point of view of the management object MO2 acting as request object there exist, under these circumstances, two independent service objects DON3 and DON4. Assigned to the logic service objects DON3 and DON4 are the connections VD21 and VD22, respectively, as logic transmission channels. The request manager RM finds out, for example on the basis of an object name-to-transmission channel assignment list that he is to transmit the request message AN3 over the connection VD21 and the request message AN4 over the connection VD22 to the discriminator object DO2.

From this, the discriminator object DO2 finds out that it receives the request message AWN3 over the connection V21 and that it is to provide a first service for the management object MO2, namely the reporting of the event state of the managed object VO2. Correspondingly, it transmits an interrogation or request message via the connection W2 to the managed object VO2 that the latter answers by means of one or more messages relating to its event state. Said messages are filtered by the discriminator object DO2 on the basis of the filtering criteria K21, which are to be used for request messages received over the connection VD21.

Similar remarks apply to the request message AN4 that is received over the connection VD22 and in which a second service is requested from the discriminator object DO2: the interrogation of the event state of the managed object VO3. The discriminator object DO2 therefore interrogates the event state of the latter via the connection W3 and filters the answer messages received in response thereto with the aid of the filtering criteria K22 that are assigned to request messages received over the connection VD22.

The items of event information reported to the management object MO2 by the discriminator object DO2 and satisfying the filtering criteria K21 and K22 are entered by the management object MO2 in its event mirror MORM in the manner already mentioned.

Solely on the basis of the allocation of one logic transmission channel VD21 and VD22 in each case to a service to be provided, the discriminator object DO2 can detect said service. The request messages AN3 and AN4 or request messages derived therefrom could therefore in principle be transmitted to the discriminator object DO2 by the request manager RM even without the object names DON3 and DON4, respectively, as identifier for the service to be provided.

It is also possible for a discriminator object to receive request messages relating to various services and/or request messages relating to various management objects on one transmission channel. For example, the discriminator object DO2 could receive over the connection VD21 the request messages AN3 and AN2 that each relate to an interrogation of the event state of the managed object VO2 and in which the address of the management object MO2 or MO1, respectively, is specified as source/destination identifier. The discriminator object DO2 then interrogates in the manner explained the event state of the managed object VO2. The items of event information then received are filtered by the discriminator object DO2 on the basis of the filtering criteria K21 if they relate to the source/identifier MO2, that is to say relate to the management object MO2, and on the basis of the filtering criteria K23 if they relate to the management object MO1.

Variants and developments of the invention are readily possible:

The discriminator objects DO1 and DO2 could be provided solely to interrogate event states in the managed objects VO1, VO2, VO3. For spontaneous event reports transmitted by the latter, separate objects or agents could be provided, for example EFDs.

The discriminator objects DO1 and DO2 serving as service objects could derive the respective service to be provided, in the exemplary embodiment the filtering criteria or the event state reports, also from a source identifier of the management objects MO1, MO2 acting a request objects. If the discriminator object DO1 receives, for example, a request message from the management object MO1, it transmits all the event states relating to the managed object VO1, whereas it transmits, in the case of a request message transmitted by the management object MO2, possibly having the same address for the discriminator object DO1 as in the request message transmitted by the management object MO1, only a selection of event states, for example particularly critical alarm states. On the other hand, general items of information, for example cyclic measurements, are separated out on the basis of filtering criteria that are not shown.

The discriminator objects DO1 and DO2 acting as logic service objects could be constructed in each case as a cascade of processes or agents, in which case, for example, a central control process or control agent receives in each case the request messages from the management objects MO1, MO2 acting as request objects and, depending on the service requested, distributes them further to subprocesses or subagents.

The discriminator objects DO1 and DO2 could be incorporated completely or partly in subfunctions in the managed objects VO1, VO2, VO3.

The functions of the discriminator objects DO1 and DO2 can be designed as controllable by the management objects MO1, MO2 and/or by the request manager RM. For example, the spontaneous transmission of event reports to the discriminator objects DO1 and DO2 could be disabled or enabled by the management objects MO1, MO2.

Furthermore, the discriminator objects DO1 and DO2 could report their respective status to the management objects MO1, MO2 and/or the request manager RM. For example, the discriminator objects DO1 and DO2 could report their creation, their deletion, their working state (operational or non-operational) or a configuration data or attribute value change.

The management objects MO1, MO2, the request manager RM, the discriminator objects DO1 and DO2 and the managed objects VO1, VO2, VO3 could each be performed individually or in groups by separate computers spatially remote from one another or by computer networks. Furthermore, different assignments could be provided. For example, the management object MO1 and the discriminator object DO2 could be assigned to the server SV1 and the management object MO2 and the discriminator object DO1 to the server SV2. To readjust the event states stored in each case in the servers SV1 and SV2, the management object MO1 could then transmit request messages to the discriminator object DO2 and the management object MO2 could transmit request messages to the discriminator object DO1.

Furthermore, the servers SV1 and SV2 could belong to separate, but mutually interconnected network management systems.

As distinct from the examples disclosed, in which the management objects, the managed objects and the discriminator objects are each designed as processes or process groups whose program code is performed by a computer or a computer network, the objects could also be formed, so to speak, by hardware. For example, the managed objects VO1 and VO2 could be formed by the network devices SW1 and SW2, respectively, and the discriminator object VO1 by a server assigned to the managed objects VO1, VO2.

It goes without saying that it is not only the management objects and discriminator objects explained in the exemplary embodiment that may serve as request objects or service objects according to the invention. For example, a managed object could also form a service object and, depending on the object name it is addressed under, it could forward, for example, messages comprising cyclic measurements or comprising alarm reports. Furthermore, a service object for a telecommunications network that controls, for example, call diversions in an intelligent network could perform various functions, for example direct call diversions to various destinations depending on the object names with which it is invoked.

1. Method of providing services, in particular in a network management system having an open system architecture, the method comprising:
assigning at least a first and a second object name to a service object;
a request object forwards to the service object a request message in which the first or the second object name is specified as address information for the service object; and
depending on the first or second object name used in the respective request message, the service object provides at least a first or a second service.

2. Method according to claim 1, wherein the service object provides the first service and/or the second service depending on the first and second configuration data, respectively.

3. Method according to claim 1, wherein the request object forwards the request message via a request manager to the service object, in that the request manager passes on the request message or a request derived therefrom via a first or a second, in particular logic transmission channel to the service object that is assigned to the first or second object name, respectively, and the service object provides the first or the second service, respectively, depending on the first or second transmission channel, respectively, used for the respective request message.

4. Method according to claim 1, wherein the service object invokes at least a further object, in particular an object managed by the request object, to provide the first and/or second service.

5. Method according to claim 1, wherein the request object is formed by a management object and the service object by a discriminator object and the discriminator object transmits to the management object event reports and/or at least one event state of at least one (first) object managed by the management object.

6. Method according to claim 5, wherein the discriminator object applies first or second filtering criteria, depending on the first or second object name used in the respective request message, to detect the events relevant to the management object in the event reports and/or in the at least one event state.

7. Method according to claim 5, wherein the discriminator object transmits an interrogation message to the at least one first managed object and/or to a second managed object to interrogate its respective, at least one event state, depending on the first or second object name used in the respective request message.

8. Service object for providing services, in particular in a network management system having an open system architecture,
to which at least a first object name and a second object name are assigned,
that has receiving means for receiving a request message in which the first or the second object name is specified as address information for the service object, and
that has service providing means for providing at least a first or a second service depending on the first or second object name used in the respective request message.

9. Service object according to claim 8, wherein it contains a program code that can be performed by a control means of a server.

10. Request object for utilizing services, in particular in a network management system having an open system architecture, comprising transmission means for transmitting at least one request message for a first and/or a second service to be provided by a service object, wherein the transmitting means are designed in such a way that the request object can specify, in the at least one request message, a first or a second object name assigned to the respective service object as address information for the service object depending on the respective first or second service to be provided by the service object.

11. Request object according to claim 10, wherein it contains a program code that can be performed by a control means of a server.

12. Request manager for providing services, in particular in a network management system having an open system architecture,
comprising receiving means for receiving a request message transmitted to a service object by a request object in which at least a first or a second service is requested by the service object depending on a first and/or second object name assigned to the service object and used in the respective request message as address information,
comprising transmitting means for transmitting the request message or a request derived therefrom via a first or a second, in particular logic transmission channel, respectively, to the service object that is assigned to the first or second object name so that the service object can provide the first or the second service, respectively, depending on the first or second transmission channel used for the respective request message.

13. Request manager according to claim 12, wherein it contains a program code that can be performed by a control means of a server.

14. Memory means, in particular diskette or CD-ROM, digital versatile disk, harddisk drive or the like, comprising a service object according to claim 9 stored thereon and/or comprising a request object according to claim 11 stored thereon and/or comprising a request manager according to claim 13 stored thereon.
